(19) United States
(12) Patent Application Publication
(10) Pub. No.: US 2013/0096964 A1
(43) Pub. Date: Apr. 18, 2013

(54) SEAT MANAGEMENT SYSTEM

(71) Applicants: HORNG-JI CHEN, Hsinchu (TW); Chiung-Fang Liang, New Taipei City (TW)

(72) Inventors: HORNG-JI CHEN, Hsinchu (TW); Chiung-Fang Liang, New Taipei City (TW)

(73) Assignee: ClarIDy Solutions, Inc., Hsinchu City (TW)

(21) Appl. No.: 13/650,333

(22) Filed: Oct. 12, 2012

(30) Foreign Application Priority Data
Oct. 14, 2011 (TW) 100137606

(51) Int. Cl. G06Q 10/02

(52) U.S. Cl. 705/5

(57) ABSTRACT

The present invention relates to a seat management system and method designed to use a wireless communication means for managing seats in a public space, which can perform operations including: a personnel management operation using a radio frequency identification (RFID) system or a barcode system; a seat reservation operation using a multimedia kiosk with internet connection; and an operation of user login and management using at least one control unit. With the aforesaid system, the use rate of devices available for public usage in the public space can be increased while allowing any user to easily reserve a device or acknowledge the device is under usage, so that not only the service quality of the public space can be improved and the work load of the same is relieved and shared by the seat management system, but also the utilization efficiency of the public resource is enhanced.

### FIELD OF THE INVENTION

The present invention relates to a seat management system and method designed to use a wireless communication means for managing seats in a public space, which can performed operations including: a seat reservation operation using multimedia kiosks with internet connection; an operation of user management and user login control using at least one control unit embedded with a radio frequency identification (RFID) system or a barcode system; and regional seat management operation using a wireless means. With the aforesaid system, not only the service quality of the management personnel to the public space can be improved as the work load of the same is relieved and shared by the seat management system, and also the resource utilization efficiency of the public space is enhanced.

### BACKGROUND OF THE INVENTION

Radio-frequency identification (RFID) is a technology that uses communication via radio waves to exchange data between a reader and an electronic tag attached to an object or carried by a person, for the purpose of identification and tracking. Generally, an radio-frequency identification system involves RFID readers, RFID tags, and an application system. It is noted that the RFID system can be designed to operate using RFID tags of different radio frequencies under different regulations, including low-frequency (LF) RFID tags at 134 KHz typically, high-frequency (HF) RFID tags at 13.56 MHz, ultra-high-frequency (UHF) RFID tags at 860˜960 MHz, and microwave RFID tags at 2.4 GHz, and so on. The passive RFID tags have no power source internally and require an external electromagnetic field, that is mostly emitted from RFID readers, to power and activate an internal analog circuit embedded in the passive RFID tags for the chip operations. Generally, such RFID tag can be embedded with memories for data storage, and the memories can be read-only memories (ROM), write-once-read-many (WORM) memories or rewritable memories (such as EEPROM). An RFID reader supplies power to a passive RFID tag for operation, which is named “RFID reader”, but actually has functions of reading and writing data in the memory of the RFID tag.

Generally, the applications of wireless communication that are common today include: wireless local area network (WLAN), wireless metropolitan, wireless personal area network (WPAN), global system for mobile communication (GSM), long term evolution (LTE) in the third generation partnership project (3GPP), ZigBee network, Bluetooth network, proprietary wireless communication system, and so forth. Here the ZigBee network includes the communication technology of ZigBee protocol and IEEE 802.15.4 protocol.

It is noted that for most public resources, such as seats or other devices available for public usage in a public space, the reservation or application for usage can only be carried out through network or using personnel counter service, and more particularly, the availability of those seats or other devices available for public usage in the public space can only be determined manually by management personnel who make his inspection tour periodically in the public space. Until now, the automation for determining the availability of each individual seat or device in a public area is still a difficult task to achieve. Thus, the waste in public resource utilization can be caused most frequently by the insufficiency in manpower managing a public space due to tight budget control. That is, in a condition when a seat in a library reading room is being found that it is currently not being occupied by any user, in most time a management personnel might not be able to determine in time that the seat is still being taken but the user is left shortly for other business, or the seat is available despite that there is some items left on the seat that are belonged to a previous user, but are forgotten or unwanted, since the management personnel is not able to keep track of all the usage condition of the seats in the reading room simultaneously. Consequently, it is most often seen is a library room that there are plenty of seats that are not occupied, but still there are many users waiting in line for an empty seat. Therefore, it is commonplace that the resource utilization efficiency in a public space is low, but there is no way a management personnel can do to improve it. Therefore, it is in need of an improved seat management system for overcoming the aforesaid shortcomings

### SUMMARY OF THE INVENTION

In view of the disadvantages of prior art, the object of the present invention is to provide a seat management system and method designed to use a wireless communication means for managing seats in a public space, which can performed operations including: a seat reservation operation using multimedia kiosks with internet connection; an operation of user management and user login control using at least one control unit embedded with a radio frequency identification (RFID) system or a barcode system; and regional seat management operation using a wireless means. With the aforesaid system, not only the service quality of the management personnel to the public space can be improved as the work load of the same is relieved and shared by the seat management system, and also the resource utilization efficiency of the public space is enhanced. It is noted that the public space can be a library, a public reading room, a public activity center, a convention center, or an exhibition hall, etc. However, the application of the present invention is not limited to the public space, but can also be applied as internal resource management and control for any organization or private enterprise.

To achieve the above object, the present invention provides a seat management system, for automatically managing seats and devices available for public usage in a public space through the integration of a wireless communication technique, an automatic identification technique, a computer networking, a seat control apparatus, and a software application for reservation and login control. The seat management system comprises:
a network system, for connecting apparatuses including host computer, multimedia kiosks, wireless communication base stations, personal computers, network terminals, etc., so as to enable seat management operations including reservation, on-site registration, user login, and so on;
a host computer, embedded with database and files of seat management, for performing a plurality of seat management and control operations;
a multimedia kiosk, provided for users to proceed thereat with the seat management and control operations including reservation, on-site registration, user login, and so on;
at least one web browser device, each for carrying out the seat reservation operation;
at least one seat control unit, each capable of being designated to one seat or device in the public space so as to be used for defining the working status of the designated seat or device as well as controlling the functions of the same;
at least one user ID card, each embedded with at least one radio frequency identification (RFID) tag or one barcode for enabling a user who carried thereby to be identified automatically as well as controlling the allocation of a seat or device for the user;
at least one power control unit, each being used for controlling the power supply to the corresponding device and/or light in the public space relating to the corresponding seat;
a wireless communication system, including at least one wireless communication base station, for connecting to the at least one seat control unit wirelessly so as to transmit the information relating to the designated seat or device to the seat management system for the seat management operations; and
a software application for reservation and login control, for providing functions including reservation, on-site registration and user login.

Preferably, the software for reservation and login control further comprises:
a network seat reservation control module;
a multimedia kiosk seat reservation control module;
a multimedia kiosk on-site registration control module;
a multimedia kiosk user login control module; and
a system management and statistic analysis control module.

Preferably, each of the at least one seat control unit is a wireless control unit for seat management that is adapted to be disposed on a desk relating to a seat in the public space or a device in the public space so as to be used for allowing a user of the seat or device to proceed with the defining of the working status of the designated seat or device as well as the controlling of the functions of the same, and each seat control unit comprises:
an antenna, arranged inside the seat control unit to be used for communicate radio signals while enabling the radio signals to be sent to a wireless communication module for enabling operations of data transmission and system control;
an automatic identification module, arranged inside the seat control unit to be used for identifying the at least one user ID card automatically in the proceeding of the seat management operation;
a display unit, for displaying operation information;
at least one control button, each being used for enabling one control function, such as suspend and leave, etc.
at least one universal input/output port, for providing access to the at least one power control unit or other devices in the public space;
a prompt unit, for prompting user-related information;
a digital communication interface, for providing a digital communication ability to the seat control unit; and
a power supply interface, for providing power to the seat control unit.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing the architecture of a seat management system of the present invention.

FIG. 2 is a front view of a seat control unit used in a seat management system of the present invention.

FIG. 3 is a rear view of a seat control unit used in a seat management system of the present invention.

FIG. 4 is a flow chart depicting the steps performed in a seat management system of the present invention for reserving a seat through network.

FIG. 5 is a flow chart depicting the steps performed in a seat management system of the present invention for reserving a seat using a multimedia kiosk.

FIG. 6 is a flow chart depicting the steps performed in a seat management system of the present invention for on-site registration using a multimedia kiosk.

FIG. 7 is a flow chart depicting the steps performed in a seat management system of the present invention for user login using a multimedia kiosk.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

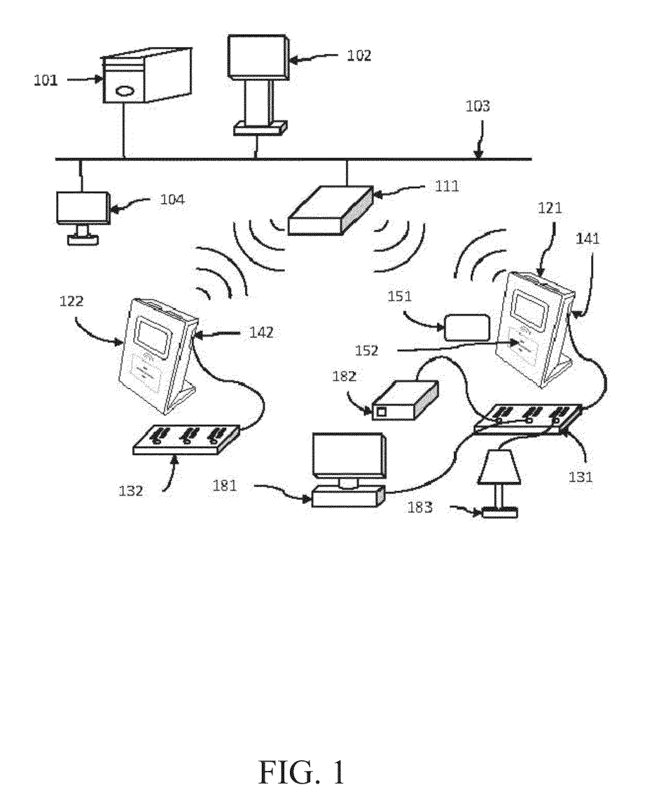

Please refer to FIG. 1, which is a schematic diagram showing the architecture of a seat management system of the present invention. It is noted that the seat management system is used for controlling operations relating the reservation and management for facilities in a public space, including desk, seats, lights, computers, and other related devices. The seat management system of the invention is capable of automatically managing seats and devices available for public usage in a public space through the integration of a wireless communication technique, an automatic identification technique, a computer networking, a control means for seat management, and a software application for reservation and login control. As shown in FIG. 1, the host computer 101 can be a device selected from the group consisting of: a mainframe computer, a server, a workstation, a personal computer and an industrial computer, whichever is capable of performing a plurality of seat management and control operations; the multimedia kiosk 102 is provided for users to proceed thereat with the seat management and control operations including reservation, on-site registration, user login, and so on; the network 102 is composed of a computer network and a radio communication network, in which the radio communication network can be a wireless local area network (WLAN), a network of wireless metropolitan, a wireless personal area network (WPAN), a network of global system for mobile communication (GSM), a network of long term evolution (LTE) in the third generation partnership project (3GPP), a network of ZigBee network, a Bluetooth network, or a network of proprietary wireless communication system; and the web browser 104 can be a device selected from the group consisting of: a personal computer, a notebook computer, an industrial computer, a tablet computer, a smart phone and a terminal, whichever is capable of executing a web browsing software for performing operations relating to seat reservation.

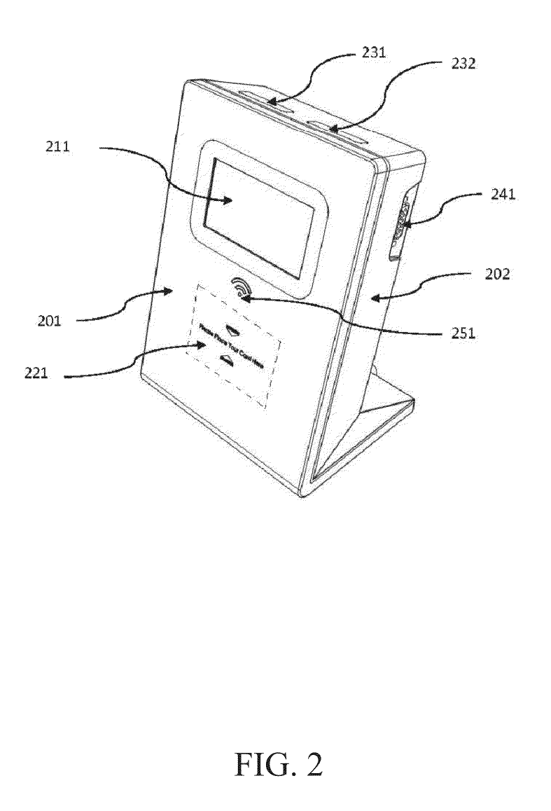

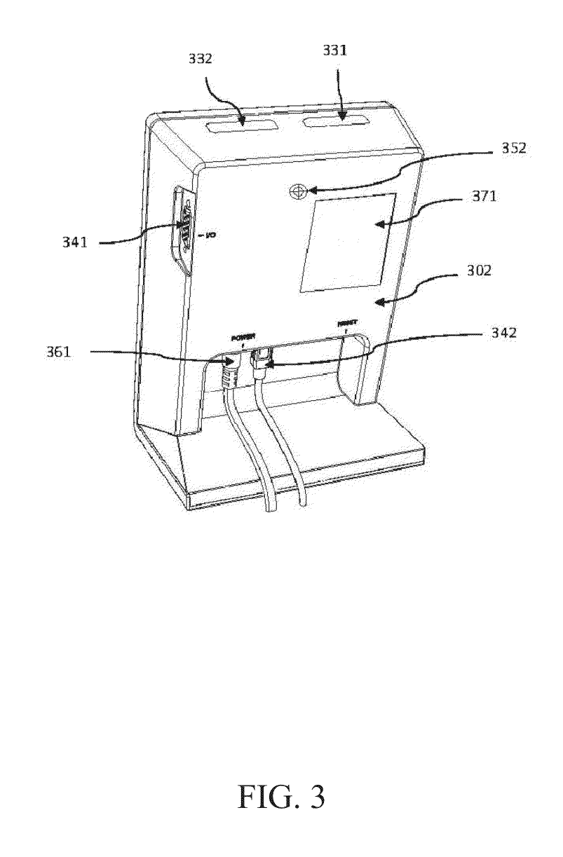

In addition, the radio communication network has at least radio base station 111, such as an access point, a mobile phone base station, or a ZigBee network coordinator, that can be used for connecting computers with network access ability, cellular phones, and ZigBee end devices with one another. Please refer to FIG. 2 and FIG. 3, which show a seat control unit used in a seat management system of the present invention. As shown in FIG. 1, FIG. 2 and FIG. 3, each seat control unit 121, 122 further comprises: an embedded wireless communication module 371, capable of connecting to the radio base station 111 so as to utilize the network to connect to the host computer 101; an embedded automatic identification module 152, capable of using signals from a radio frequency identification (RFID) reader and an antenna to identify the RFID tag attached on at least one user ID card 151 automatically in the proceeding of the seat management operation, whereas the RFID tag can be a low-frequency RFID tag, a high-frequency RFID tag or an ultra-high-frequency RFID tag; an universal input/output port 141, 142, for providing access to the power control 131, 132 of a computer 181, a lighting device 183 or a facility 182. whereas the computer 181 can be a personal computer, a notebook computer, a tablet computer, a network terminal, a smart phone, a personal digital assistant (PDA), and the like, and the facility 182 can be a projector, a video player, an iPad, an iPod, a smart phone, a electronic book reader or video conference equipment, and the light device 183 can be a light bulb, a fluorescent light, a halogen light or an LED light. In an embodiment. instead of the RFID reader, the automatic identification module 152 can be embedded with a barcode reader for reading a barcode printed on the user ID card.

As shown in FIG. 2 and FIG. 3, the seat control unit, if it is formed as a vertical-type device, is composed of a front cover 201 and a back cover 202, 302; and if it is formed as a horizontal-type device, it is composed of a top cover and a bottom cover, but it is not limited thereby and can be constructed using any housing design as required. As shown in FIG. 2, there is a display unit 211 fitted on the front cover 201, which can be a liquid crystal display, a flat panel display, a light emitting diode display or an electronic paper display, whichever is capable of displaying operation information. In addition, the automatic identification module 221 in the seat control unit can be composed of a radio frequency identification (RFID) reader and an antenna so as to enable the same to detect and inspect the RFID tag attached to the user ID card 151 automatically in the proceeding of the seat management operation. The shell at the antenna area should be a non-metallic material for the transmission of radio frequency signals. However, if there is only a barcode printed on the user ID card 151, the automatic identification module 221 is able to use a barcode reader embedded therein for accessing the barcode so as to proceed with the seat management operation. It is noted that the information contains in the user ID card 151 is at least one of an unique ID (UID) of the RFID tag, an electronic product code (EPC) of the RFID tag, a data registered in the memory of the RFID tag, or a barcode. In FIG. 2 and FIG. 2, the seat control unit is configured with two control buttons 231, 232, and 331, 332, and each of which is used for enabling one control function, such as suspend and leave, etc. The prompt unit 251, being used for prompting user-related information, can be an assembly of lights, whereas each light can be a light emitting diode (LED), a flash light, a fluorescence light, or a light bulb, and the prompt unit 251 of light assembly is capable of enabling lights of different colors to light on in various pattern or to flash respectively with different periods so as to prompt the user-related information accordingly. In another embodiment, the prompt unit 352 can substantially be an audio device, such as a speaker or a buzzer, whichever is capable of issuing sounds of different frequencies, music of different melodies, or various series of sounds with different intermittent intervals, so as to prompt the user with different user-related information. Moreover, the seat control unit further has a digital communication interface 342 which can be an interface selected from the group consisting of: an Ethernet computer network interface, a RS-232 interface, a RS-485 interface, a RS-422 interface, and an USB interface, whichever is capable of connecting to the computer 181 therethrough for performing operations, such as updating the firmware of the seat control unit. As shown in FIG. 2, and FIG. 3, the seat control unit further has a universal input/output port 241, 341, that is used for providing access to the power controls of the computer 181, the lighting device 183 and the facility 182. It is noted that the power controls can be varied according to the devices that are controlled thereby. For instance, the power control for the lighting device 183 can simply be a power switch, while the power control for the computer 181 is a functional enable/disable switch that can prevent the hard disk in the computer from being damaged by suddenly power outage. Moreover, the power switch for the lighting device 183 can be a relay whose on/off can be controlled directly by signals transmitted from the universal input/output port 241, 341; and functional enable/disable switch for the computer 181 is controlled by the enable/disable command issued from the computer 181 whereas the enable/disable command is generated from a software application embedded inside the computer 181 according to signals from the universal input/output port 241. In addition, the seat control unit further has a power supply interface 361, which is used for providing power to the seat control unit.

In an embodiment of the invention, the software for reservation and login control further comprises: a network seat reservation control module; a multimedia kiosk seat reservation control module; a multimedia kiosk on-site registration control module; a multimedia kiosk user login control module; and a system management and statistic analysis control module. The following description is provided for describing the steps performed respectively in the aforesaid modules.

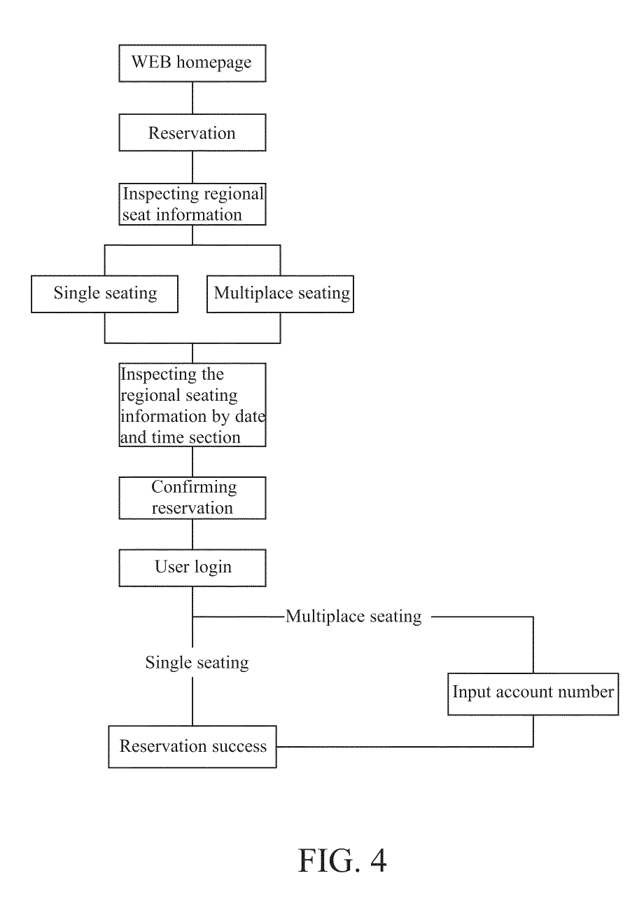

Please refer to FIG. 4, which is a flow chart depicting the steps performed in a seat management system of the present invention for reserving a seat through network. In FIG. 4, the flow chart reveals steps that are preformed in a network seat reservation control module programmed in the reservation software of the seat reservation system, using which a user is able to reserve either a seat for individual or a space with multiple seats for meeting through a network or internet. It is noted that the space with multiple seats can be a meeting room or a table with multiple seats. Operationally, first a regional information relating to the distribution of seats that are provided for public usage is posted on the web page of the public space, on which the reserved and unreserved seats are clearly and distinctively indicated in graphic drawings or tables. In addition, as the regional seat information can varied by dates and by time sections, a user that is to reserve a seat in the public space will first select and confirm a date and time section so as to have access to the proper regional seat information for checking whether there is a seat available at the time when the seat is needed, and if so, the user is then able to login the seat reservation system for completing the seat reservation operation using user ID card 151 or account number.

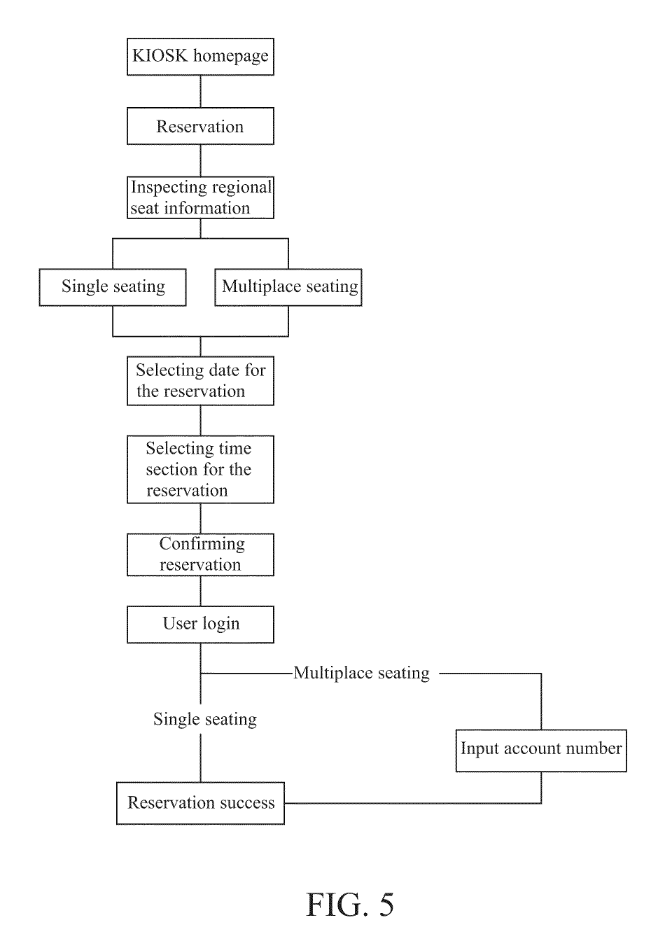

Please refer to FIG. 5, which is a flow chart depicting the steps performed in a seat management system of the present invention for reserving a seat using a multimedia kiosk. In FIG. 5, the flow chart reveals steps that are preformed in a multimedia kiosk seat reservation control module programmed in the reservation software of the seat reservation system, using which a user is able to reserve either a seat for individual or a space with multiple seats for meeting through a multimedia kiosk. It is noted that the space with multiple seats can be a meeting room or a table with multiple seats. In addition, the multimedia kiosk can be configured with an automatic identification module, and the automatic identification module can be composed of a RFID reader and an antenna for allowing the same to interrogate with the RFID tag to identify the user ID card 151 in the proceeding of a seat reservation operation. In another embodiment, the automatic identification module can substantially be a barcode reader to be used for reading a barcode printed on the user ID card 151 in the proceeding of a seat reservation operation. Nevertheless, the automatic identification module can be constructed with the RFID tag interrogation ability and the barcode reading ability at the same time if required. In this multimedia kiosk seat reservation control module, the management staff of the public space is enabled to determine whether to allow the user to select a seat from a list of available seat at will or simple select a seat for the user automatically. Operationally, first a regional information relating to the distribution of seats that are provided for public usage is posted on the multimedia kiosk web page, on which the reserved and unreserved seats are clearly and distinctively indicated in graphic drawings or tables. In addition, as the regional seat information can varied by dates and by time sections, a user that is to reserve a seat in the public space will first select and confirm a date and time section so as to have access to the proper regional seat information for checking whether there is a seat available at the time when the seat is needed, and if so, the user is then able to login the seat reservation system for completing the seat reservation operation using user ID card 151 or account number.

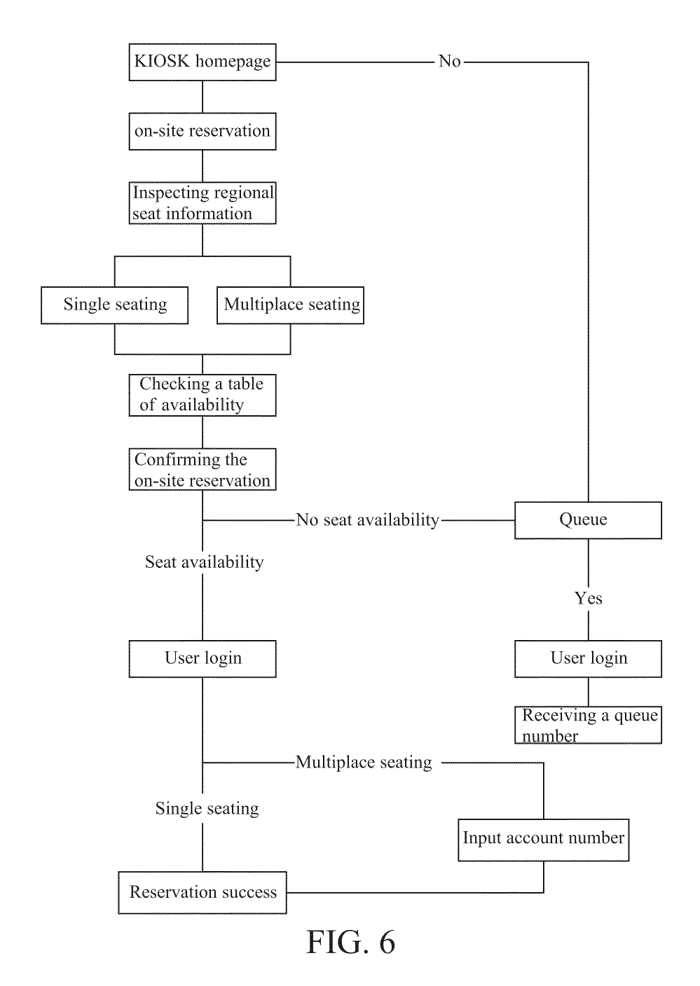

Please refer to FIG. 6, which is a flow chart depicting the steps performed in a seat management system of the present invention for on-site registration using a multimedia kiosk. It is noted that the on-site registration is limited to reserve seats on the same day of the registration, but is allowed to select any time section in the same day, and similarly, the management staff of the public space is enabled to determine whether to allow the user to select a seat from a list of available seat at will or simple select a seat for the user automatically. Operationally, first a regional information relating to the distribution of seats that are provided for public usage is posted on the multimedia kiosk web page, on which the reserved and unreserved seats are clearly and distinctively indicated in graphic drawings or tables. In addition, as the regional seat information can varied by time sections, a user that is to reserve a seat in the public space will first select and confirm a time section so as to have access to an availability table with the proper regional seat information for checking whether there is a seat available at the time when the seat is needed, and if so, the user is then able to login the seat reservation system for completing the seat reservation operation using user ID card 151 or account number. It is noted that in this on-site registration module, each time section can be a fixed time unit, e.g. a period of one hour, according to that a user who selects a seat at 9:15 a.m. that is available at the time section of 9:00 a.m. to 10:00 a.m. but is under reservation at the time section of 10:00 a.m. to 11:00 a.m., can only use the seat starting from 9:15 a.m. and have to end at 10:00 a.m. Moreover, if there is no seat available, the user can determine whether to join a queue of waiting list; and if the user decides not to join the queue, the seat reservation operation will be stopped; otherwise, the user will be asked to login using the user ID card 151 or an account number for receiving a queue number. After receiving the queue number, the user's operation on the multimedia kiosk is finished and can leave until being notified by the seat reservation system. In an embodiment, the notification of the seat reservation system can be posted on an electronic bulletin board, whereas the electronic bulletin board can be a liquid crystal display, a light emitting diode display, a TV, or a computer monitor, whichever is capable of displaying the notification. Thus, it is noted that post of the notification can be performed by a specific electronic bulletin board, or can be posted on TV or computer monitor using push service, in a running line, or even in a sub-picture.

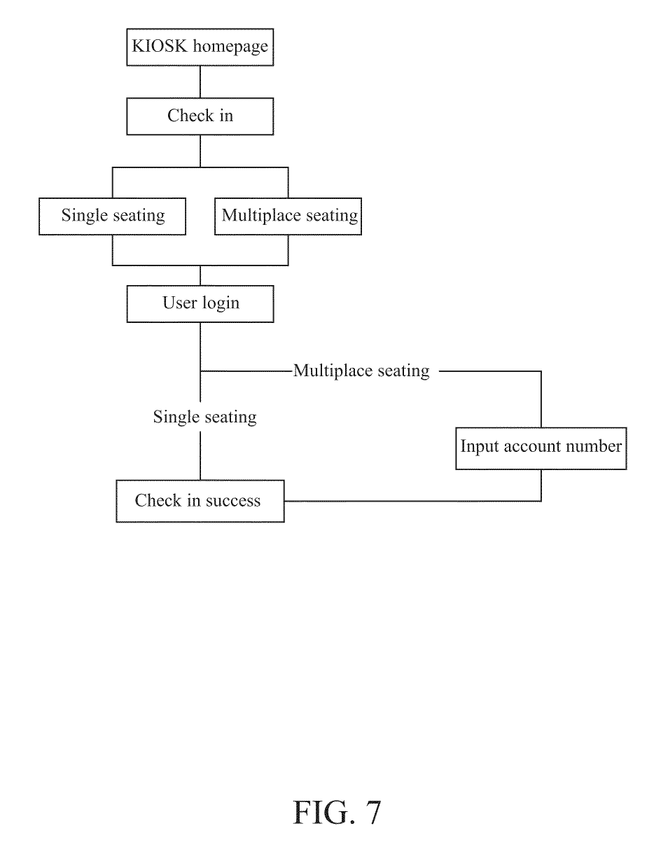

Please refer to FIG. 7, which is a flow chart depicting the steps performed in a seat management system of the present invention for user login using a multimedia kiosk. In FIG. 7, the flow chart reveals steps that are preformed in a multimedia kiosk user login control module of the seat reservation system. The multimedia kiosk user login control module is performed for allowing a user to check in for using the seat that is reserved by the user through reservation or on-site registration. After successfully checking in, the seat reservation system will indicate that the seat is occupied by the user.

However, the user login operation can be performed using the seat control unit 121, 122 instead of the multimedia kiosk. That is, at the time of reservation, the user can simply place his/her user ID card 151 near the interrogation area 152, 221 of the seat control unit 121, 122 so that the automatic identification module 221, that is composed of the RFID reader and the antenna, is enabled to interrogate with the RFID tag of the user ID card 151 for determining whether the reservation is legit; and if so, a check-in process will be enabled automatically and the display unit 211 on the seat control unit 121, 122 will display a message of check-in success while notifying the seat reservation system that the corresponding seat is occupied by the user. However, if the reservation is not legit, i.e. whether the user ID card is not conforming to the one used for the reservation, or the time of interrogation is not conforming to the reservation time, an error message will be display on the display unit 211 of the seat control unit 121, 122 for prompting the user to deal with the error. Nevertheless, in a condition that the user need to take a leave temporarily, he/she can use the control button 231, 232 to enable a suspension operation with a predefined duration of suspension for disenabling the display unit of the computer 182 or disenabling the facility 182, and then, after returning from the break and the reservation is still valid as the break is not longer than the predefined duration of suspension, the user can simply place his/her user ID card 151 near to the automatic identification module 152, 221 for allowing the display unit of the computer 182 or the facility 182 to be enabled. However, if the reservation is expired while the leaving time of the user is longer than the predefined duration of suspension, the seat will be released from the suspension and become available for the next user in the waiting queue. It is noted that the predefined duration of suspension is determined by the management staff of the public space under the consideration for minimizing resource waste. Moreover, if the user is going to leave before his/her reservation expired, the user can simply use the control button 231, 232 to enable a leave operation for trigging the seat to be released to the seat reservation system and become available for the user next in the waiting queue.

For the system management and statistic analysis control module in the reservation software, it is provided for the management staff of the public space to set up all kinds of seat management rules for the seat reservation system that can be used for governing the operation of all the other modules embedded in the software while calculating various statistical analyses for improving the utilization efficiency of the public resource available in the public space.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A seat management system, for automatically managing seats and devices available for public usage in a public space through the integration of a wireless communication technique, an automatic identification technique, a computer networking, a control means for seat management, and a software application for reservation and login control, the seat management system comprising:
a host computer, embedded with database and files of seat management, for performing a plurality of seat management and control operations;
a multimedia kiosk, provided for users to proceed thereat with the seat management and control operations including reservation, on-site registration, user login, and so on;
a network system, for connecting apparatuses including the host computer, the multimedia kiosk, a wireless communication base station, a personal computer or a network terminal, so as to enable seat management operations including reservation, on-site registration, user login, and so on;
at least one web browser device, each for carrying out the seat reservation operation;
at least one seat control unit, each capable of being designated to one seat or device in the public space so as to be used for defining the working status of the designated seat or device as well as controlling the functions of the same;
at least one user ID card, each embedded with at least one radio frequency identification (RFID) tag or a barcode for enabling a user who carried thereby to be identified automatically as well as controlling the function of a seat or device that is used by the user;
at least one power control unit, each being used for controlling the power supply to the corresponding device or light in the public space relating to the corresponding seat;
a wireless communication system, including at least one wireless communication base station, for connecting to the at least one seat control unit wirelessly so as to transmit the information relating to the designated seat or device to the seat management system for the seat management operations; and
a software application for reservation and login control, for providing functions including reservation, on-site registration and user login.

2. The seat management system of claim 1, wherein the software for reservation and login control further comprises:
a network seat reservation control module;
a multimedia kiosk seat reservation control module;
a multimedia kiosk on-site registration control module;
a multimedia kiosk user login control module; and
a system management and statistic analysis control module.

3. The seat management system of claim 1, wherein the wireless communication system adopts a communication technology selected from the group consisting of: a network of wireless local area network (WLAN), a network of wireless metropolitan, a network of wireless personal area network (WPAN), a network of global system for mobile communication (GSM), a network of long term evolution (LTE) in the third generation partnership project (3GPP), a ZigBee network, a Bluetooth network, and a network of proprietary wireless communication system.

4. The seat management system of claim 1, wherein the web browser device is a device selected from the group consisting of: a personal computer, a notebook computer, an industrial computer, a tablet computer, a smart phone and a terminal, which is capable of executing a web browsing software for performing operations relating to seat reservation.

5. The seat management system of claim 1, wherein each of the at least one seat control unit is a wireless control unit for seat management that is adapted to be disposed on a desk relating to a seat or a device in the public space so as to be used for allowing a user of the seat or device to proceed with the defining of the working status of the designated seat or device as well as the controlling of the functions of the same, and each seat control unit further comprises:
an antenna, arranged inside the seat control unit to be used for transceiving radio signals while enabling the radio signals to be sent to a wireless communication module for enabling operations of data transmission and system control;
an automatic identification module, arranged inside the seat control unit to be used for identifying the at least one user ID card automatically in the proceeding of the seat management operation;
a display unit, for displaying operation information;
at least one control button, each being used for enabling one control function, such as suspend and leave, etc.
at least one universal input/output port, for providing access to the at least one power control unit or other devices in the public space;
a prompt unit, for prompting user-related information;
a digital communication interface, for providing a digital communication ability to the seat control unit; and
a power supply interface, for providing power to the seat control unit.

6. The seat management system of claim 5, wherein for enabling the antenna to communicate the radio signals, the area of a shell of the seat control unit that is corresponding to the radio signal transceiving is made of a non-metallic material.

7. The seat management system of claim 5, wherein the communication technology used in the wireless communication module is the same as the one used in the wireless communication system, and is a technology selected from the group consisting of: a network of wireless local area network (WLAN), a network of wireless metropolitan, a network of wireless personal area network (WPAN), a network of global system for mobile communication (GSM), a network of long term evolution (LTE) in the third generation partnership project (3GPP), a ZigBee network, a Bluetooth network, and a network of proprietary wireless communication system.

8. The seat management system of claim 5, wherein the automatic identification module is composed of a radio frequency identification (RFID) reader and an antenna, that are used for identifying the at least one user ID card automatically in the proceeding of the seat management operation.

9. The seat management system of claim 5, wherein the automatic identification module is substantially a barcode reader, that is capable of identifying the at least one user ID card automatically in the proceeding of the seat management operation.

10. The seat management system of claim 5, wherein the display unit is a device selected from the group consisting of: a liquid crystal display (LCD), a flat panel display, a light emitting diode display (LED), an electronic paper display (EPD), that is capable of displaying operation information.

11. The seat management system of claim 5, wherein the digital communication interface is an interface selected from the group consisting of: an Ethernet computer network interface, a RS-232 interface, a RS-485 interface, a RS-422 interface, and an USB interface.

12. The seat management system of claim 5, wherein the at least one universal input/output port is used for providing access to the power control of a computer, a lighting device or the other equipment.

13. The seat management system of claim 5, wherein the prompt unit is capable of enabling lights of different colors to light on in various pattern or to flash respectively with different periods so as to prompt the user-related information accordingly.

14. The seat management system of claim 5, wherein the prompt unit is substantially an audio device that is capable of issuing sounds of different frequencies, music of different melodies, or various series of sounds with different intermittent intervals, so as to prompt different user-related information.
